(19) United States
(12) Patent Application Publication
(10) Pub. No.: US 2009/0003923 A1
(43) Pub. Date: Jan. 1, 2009

(54) Document indexing system

(76) Inventor: Lori Osterheldt, Northridge, CA (US)

Correspondence Address: Law Office of Robert J. Schaap, P.O. BOX 950103, Mission Hills, CA, 91395, US

(21) Appl. No.: 11/890,700

(22) Filed: Aug. 7, 2007

Related U.S. Application Data
(60) Provisional application No. 60/906,073, filed on Mar. 9, 2007.

(51) Int. Cl. B42F 3/02

(52) U.S. Cl. 402/22; 283/36

(57) ABSTRACT

A document indexing system which enables the application of index tabs, to pages of a document mounted in a binder and which document is comprised of several pages. A sheet extender may be attached to certain pages which are to have an index tab on an opposite side margin so that the pages are easily visible and engageable by the fingers of a user. The invention is effective with pre-formed commercially available index tab divider pages.

### RELATED APPLICATION

This application is based on and claims priority from my U.S. provisional patent application Ser. No. 60/906,073, filed Mar. 9, 2007, for Document Indexing System.

### BACKGROUND OF THE INVENTION

1. Field of the Invention

This invention relates in general to certain new and useful improvements in a sheet extender system for pages of a document containing a plurality of pages mountable in a binder, and more particularly, to a sheet extender system of the type stated which provides for the extension of the width of one or more of the pages of a document, whether or not included in a protective sleeve, and mountable in a binder so that index tabs on an opposite margin are visible by adding an additional width to the binder margin of those certain pages. In this way, when mounted in a binder, the tabs will be readily visible and easily engageable by the fingers of a user.

2. Brief Description of Related Art

For many documents, it is common to mount the pages of these documents in a so-called loose leaf binder, often referred to as a ring binder, such as a two-ring binder or a three-ring binder, particularly if the pages are to be changed or if new pages are to be added, or if other pages are to be removed and saved in another location in that binder. Very frequently, individual pages of a document are inserted in a protective sleeve and then mounted in a loose leaf binder, such as a two-ring binder or a three-ring binder, etc. In this way, by opening the rings, one or more pages can be introduced or removed. Binder systems of this type are quite effective and widely used, including uses in business activities, school activities, and the like.

In many cases, there are tab sheets which have a width so that the tab sheets, along with other sheets, can be mounted in a binder. Thus, as an example, a typical 8½″ by 11″ sheet may be conventionally mounted in a multi-ring binder. Tab pages similarly have the same size but are provided with outwardly extending tabs. Thus, a user may insert a marker in the tab covers to identify a particular section of a volume of pages mounted in the binder. Nevertheless, in many cases, if there are pages which are slightly wider than 8½″ in width, they can cover the tabs rendering the latter to be unobservable and even more so unengageable.

In some cases, in order to protect the integrity of the sheets of paper which may form part of the document, these pages are individually inserted into so-called “sheet protectors”. These sheet protectors are generally transparent plastic envelopes which allow the sheet to be inserted in the envelope and since the envelope is transparent, both sides of the sheet are readily visible. However, pages in a sheet protector usually have a width larger than “8½” thereby blocking both sight and engageability of the tab on the divider sheets.

One of the problems with the presently available sheet protectors, particularly those which are to be mounted in a binder, is the fact that they contain a side strip with apertures to mount in a ring binder. This side strip increases the overall width of the page in the protective sleeve such that it extends to the side beyond the margins of many of the other pages of a document.

Consequently, even when index tabs, or the like, are added to the side margins of any one or more of the pages of the document, they are not at all readily visible and moreover, they are not easily engageable by fingers of a user. In those types of situations, the tabs not only become virtually useless, but they interfere with proper turning of the pages.

It is also common to add tabs to pages of a document for a variety of reasons. These tabs may be used to segregate one or a group of pages of that document. The tabs may also be used to enable a user to quickly select that portion of the document he or she wishes to review. In addition, the tabs may be color coded so as to provide a code or a name to a certain section of pages in the document. In any event and for whatever purpose the tabs are being used, they are frequently employed and to many users, they form an integral and important part of the document.

In many school documents, tabs may be required to segregate groups of pages. In court documents, tabs may be required, pursuant to court rules, to identify exhibits to a document or to identify sections of that particular document. In any event, it is necessary for the tabs to be readily visible. If they are hidden in any fashion, they destroy the very purpose for which the tabs are present. Moreover, to protect the pages of the document each page is mounted in its own protective sleeve or jacket.

It can be seen from the foregoing, that there are numerous cases in which commercially available divider pages having tabs may be added by a user. However, these pages containing these tabs may be of insufficient width to extend beyond other pages. This is particularly true in the case where some pages are incorporated in protective sleeves. These tab pages may even have reinforced edges on the side opposite the tab where the pages are mounted in a binder. Nevertheless, if the tabs are hidden, they become ineffective for use.

### OBJECTS OF THE INVENTION

The present invention, therefore, provides certain objects which are effective to overcome problems inherent in the prior art systems of adding index tab divider pages to a document removably mounted in a binder. Certain but not all of these objects are set forth below:

It is, therefore, a primary object of the present invention to provide a system for extending the width of certain pages of a plural-page document and particularly index tab pages so that tabs on these tab pages are readily visible and engageable, even when initially covered by pages having a larger width than others of the pages.

It is also an object of the present invention to provide a tab system which provides the ability to add index tabs to a plural page document, when certain of these pages are removably located in protective transparent sleeves which extend the overall width of the sleeve-page combination to thereby enable easy viewing of the tabs on tab divider pages and to permit easy and readily available grasping of the tabs to turn pages when required.

It is another object of the present invention to provide an indexing system of the type stated in which dimensions and particularly width dimensions of one or more pages, and particularly pre-formed index divider pages, can be altered to enable the viewing of index tabs on certain of the pages and to enable easy grasping of the tabs for turning pages in a bound volume.

It is a further object of the present invention to provide supplemental strips (referred to herein as “extender strips”) to be added to one side margin of one or more pages located in protective sleeves to extend the opposite side margin or width of other pages. It is particularly desirable to add an extender strip of the type stated to conventional index tab divider pages so that the tabs on these pre-formed pages are easily visible and engageable. In this way, other pages in protective sleeves, when mounted in a binder, will not mask tabs on the outwardly facing side margins of the index tab divider pages of a document and allow those tabs to become engageable by the fingers of a user.

It is a further object of the present invention to provide an indexing system of the type stated which can be constructed at a relatively low cost and which is still highly effective in operation.

It is another salient object of the present invention to provide a method of extending the side margins of one or more pages in a plurality of pages such that index tabs on certain of those pages are readily visible and readily engageable by the fingers of a user.

It is still another important object of the present invention to effectively extend the width of a page in a document containing a plurality of pages by adding to that page, or a protective cover holding the page, a strip of a predetermined width.

With the above and other objects in view, my invention resides in the novel features of form, construction, arrangement and combination of parts presently described and pointed out in the claims.

### BRIEF SUMMARY OF THE INVENTION

The present invention is a relatively simple but highly effective system for increasing one of the dimensions of a sheet of paper or other sheet-forming material forming part of a multi-page document which can be bound in a document binder containing like pages. As indicated above, certain pages of a document may be included in a protective sleeve. When the protective sleeve has a mounting strip located on a side margin, the overall width of that page-sleeve combination is increased beyond that of other pages. This would preclude the visibility and, for that matter, the ability to grasp the tab which may exist on those other pages.

In its simplest form, the system of the invention employs a marginal strip having sufficient dimension to add to one of the dimensions of a sheet of paper or a protective sleeve for that sheet to cause an extension of the width of that sheet or sleeve. In this way pages, and particularly pre-formed index tab divider pages, having a tab on the right hand margin thereof can be included in a document and mounted in a binder. A marginal strip of the invention to be incorporated on the left-hand margin of each page, sometimes referred to as a “marginal strip”, will extend beyond other pages of the document to at least enable the extending of a tab beyond other pages or protective covers for those pages, such that the tab is easily visible and easy to grasp by a user.

More particularly, the invention relies upon marginal strips which are attached to one longitudinal margin of a sheet of paper, and particularly, the longitudinal margin which would otherwise be bound in a binder. In a preferred embodiment of the invention, this marginal strip would be attached to the binder margin or typically the left-hand margin of a conventionally provided commercially available index tab divider page. These index tab divider pages have the same size and shape as a conventional page. Therefore, with a page extender on a binder margin thereof, an index tab or index tab holder on a right-hand margin of the divider page, the index tab will extend beyond the other pages of the document.

In accordance with the present invention and as a strip sometimes referred to herein as an “extender strip” is added to the longitudinal margin of one side of a page as for example, an index tab divider page. As a simple example, a strip is added to the longitudinal margin on one side of a page and which allows a tab on the opposite longitudinal side margin of that page to extend further outwardly, so that a tab secured to that page is readily visible and engageable. The same holds true when the page is mounted in a protective sleeve which may or may not have a binder mounting strip on a side thereof. In this case, the size enlargement strips are referred to herein as “extender strips”, since they cause the side margin of a page to extend outwardly by a dimension equivalent to the width of the strip.

In a preferred embodiment these extender strips are provided with an adhesive means to enable the extender strips to be secured to one longitudinal margin of a page. More specifically, it is typically the left margin of a page such as an index tab divider page which is to be bound in a loose leaf binder or other binder. If that page was previously provided with, for example, three spaced apart ring receiving apertures for mounting in a three-ring binder, the added extender strip itself would contain the same number and spacing of the apertures on the page, and in this case, three equally spaced apart apertures for mounting on the ring system of that binder.

By adding an additional longitudinal extender strip to the page, the overall width of that page, when mounted in the binder, is thereby increased. This would enable the extension of an index tab mounted on that page to extend beyond the other pages in a volume of these pages and thereby become visible and engageable. More particularly, the adding of the extender strip to one of the pages and particularly, a pre-formed commercially available index tab divider page, would enable the opposite margin (right-hand margin) of that page to extend beyond other pages. This is particularly true when the extender strips are added to the pre-formed commercially available divider pages, or otherwise to individual pages which are included in a protective sleeve when an extender strip is mounted on the left-hand side of that protective sleeve.

It is not uncommon for many people to include portions of their documents and particularly one or two specific pages in protective sleeves which are sized to receive conventional pages of a document. In this way, the document can be protected and since the protective sleeve is transparent, matter such as printed matter contained on the pages is readily visible. However, it may be appreciated that when a page of a document is included in this protective sleeve having a binder mounting strip on a side thereof, that page normally will have a width greater than that of the other pages in the document. The width of that page in the page-sleeve combination will be greater than the other pages by at least the width of mounting strip on the sleeve.

The binder which may be used in accordance with the invention is essentially any type of binder in which pages can be mounted in that binder. Moreover, the pages can be permanently mounted or removably mounted in the binder, even when included in protective sleeves. In the preferred embodiment of the invention, this binder is typically a multi-ringed binder such as a two-ring binder, a three-ring binder or a four-ring binder in which the rings open to allow insertion and removal of pages.

Heretofore, there has not been any system which enables the application of index tabs or other index identifiers to an outer longitudinal side margin of a page so that it can be easily extended beyond other pages in a binder. This is particularly true when other pages of a document have been included in a plastic sleeve having a binder mounting strip. The present invention thereby overcomes that problem by the provision of an extender strip having widths sufficient to enable one sheet to extend beyond at least the width of all other sheets and beyond the width of all sheets in a document.

This present invention thereby provides a unique and novel document indexing system, which thereby fulfills all of the above-identified objects and other objects which will become more fully apparent from the consideration of the forms in which it may be embodied. One of these forms is more fully illustrated in the accompanying drawings and described in the following detailed description of the invention. However, it should be understood that the accompanying drawings and this detailed description are set forth only for purposes of illustrating the general principles of the invention.

### BRIEF DESCRIPTION OF THE DRAWINGS

Having thus described the invention in general terms, reference will now be made to the accompanying drawings in which:

FIG. 1 is an exploded plan view of a page of a document along with a conventional pre-formed commercially available index tab divider page;

FIG. 2 is an exploded plan view similar to FIG. 1, and showing an extender strip added to the pre-formed commercially available indexed tab divider page;

FIG. 3 is an exploded plan view of a page being inserted in a protective sleeve having a binder mounting strip on a side thereof;

FIG. 4 is a plan view of a page shown in comparison to a page in a protective sleeve of FIG. 3 to depict the additional width added to the page sleeve combination of FIG. 3;

FIG. 5 is an exploded plan view, similar to FIG. 3, and showing a tab added to a page and the comparative width relative to a page mounted in a protective sleeve with a mounting strip;

FIG. 6 is an exploded plan view of a page of a document, and a protective sleeve therefore in which a tab can be mounted to the sleeve;

FIG. 7 is an exploded plan view showing the use of an extender strip being added to a page of a document;

FIG. 8 is a perspective view showing a document page and showing the mounting of a page extender to a longitudinal edge of that page; and

FIG. 9 is a plan view showing an extender strip mounted on an edge of a protective sleeve with a document included therein and a tab on an opposite margin thereof.

### DETAILED DESCRIPTION OF A PREFERRED EMBODIMENT

Referring now in more detail and by reference characters to the drawings, there is illustrated in FIG. 1 a conventional page 100 of a document shown in relationship to a pre-formed commercially available index tab divider page 102. In this case, it can be seen that the divider page 102 has the same width as the page 100. As a result, if a number of documents were mounted in a binder, and because of the fact that the binder apertures may be larger than the overall diametric size of the ring, some pages will extend beyond a tab 104 on the divider page 102. Certainly if any one page is incorporated in a protective sleeve, that combination will extend beyond the right-hand margin of the divider page.

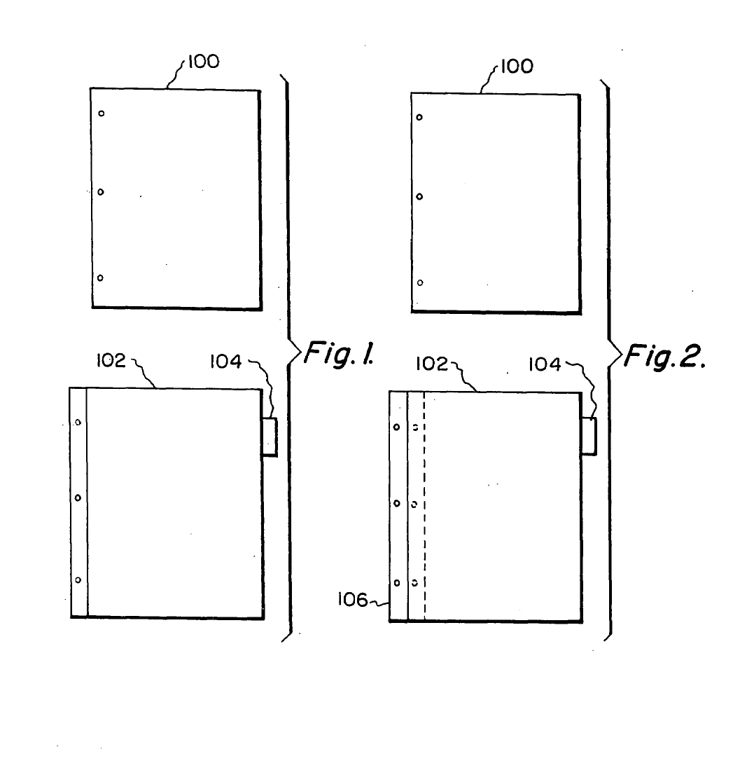

FIG. 2 illustrates that same conventional page 100 as well as the commercially available pre-formed index tab divider page 102. In this case, page 102 also is shown with an extender strip 106 on the left-hand margin. By examination of the pages shown in FIG. 2, it can be seen that with the extender strip 106 added to the commercially available pre-formed index tab divider page 102, that it extends substantially beyond the right hand margin of a conventional page 100. In this way, the tab 104 is readily visible and moreover, it is readily engageable by the fingers of a user.

Although the invention is highly effective for use with the pre-formed index tab divider pages, the extender strip of the invention is effective for use with any of a variety of documents which may be mounted in combination with other documents in the binder strips at the binder portion of a binder. Thus, the invention is not limited to use with index tab divider pages as shown. Rather, and although highly effective for use with the index tab divider pages, the invention is usable with a variety of pages where it is necessary to have tabs extended outwardly for readily engageability and visibility.

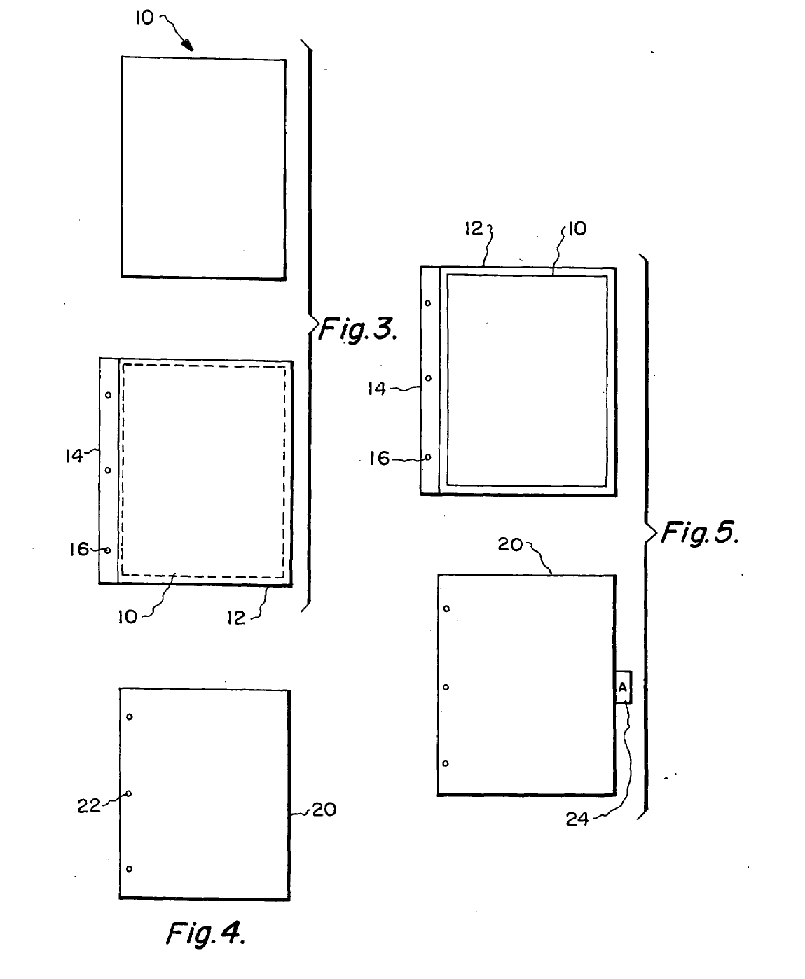

Referring now to the upper portion of FIG. 3 there is shown a document 10 and also in the lower portion of FIG. 3 is an illustration of that document 10 incorporated in a transparent protective envelope or sleeve 12 and which has a binder mounting strip 14. At this point, it can be observed that the mounting strip 14 is provided with ring receiving apertures 16 and having the proper spacial relationship for mounting in a ring binder. It can be observed by reference to FIG. 1 that the overall width of the page 10 is essentially extended by the width of the mounting strip 14.

FIG. 4 shows a page 20 having binder apertures 22. It can be observed by reference to FIG. 4 and the lower portion of FIG. 3, that a page in a protective sleeve would extend outwardly at the right hand margin well beyond the width of the page 20 not included in a sleeve, when both were mounted in a multi-ring binder.

FIG. 5 illustrates a page 10 mounted in a protective sleeve 12 of the type shown in FIG. 3 with a mounting strip 14 and binder apertures 16 in relationship to a normal page 20 having a tab 24 on the right-hand side thereof. It can be observed by reference to FIG. 5 that the page 10 mounted in the protective sleeve 12 would extend beyond or at least to the very edge of the tab 24 so that the latter would not be visible, and even more-so, would not be readily engageable.

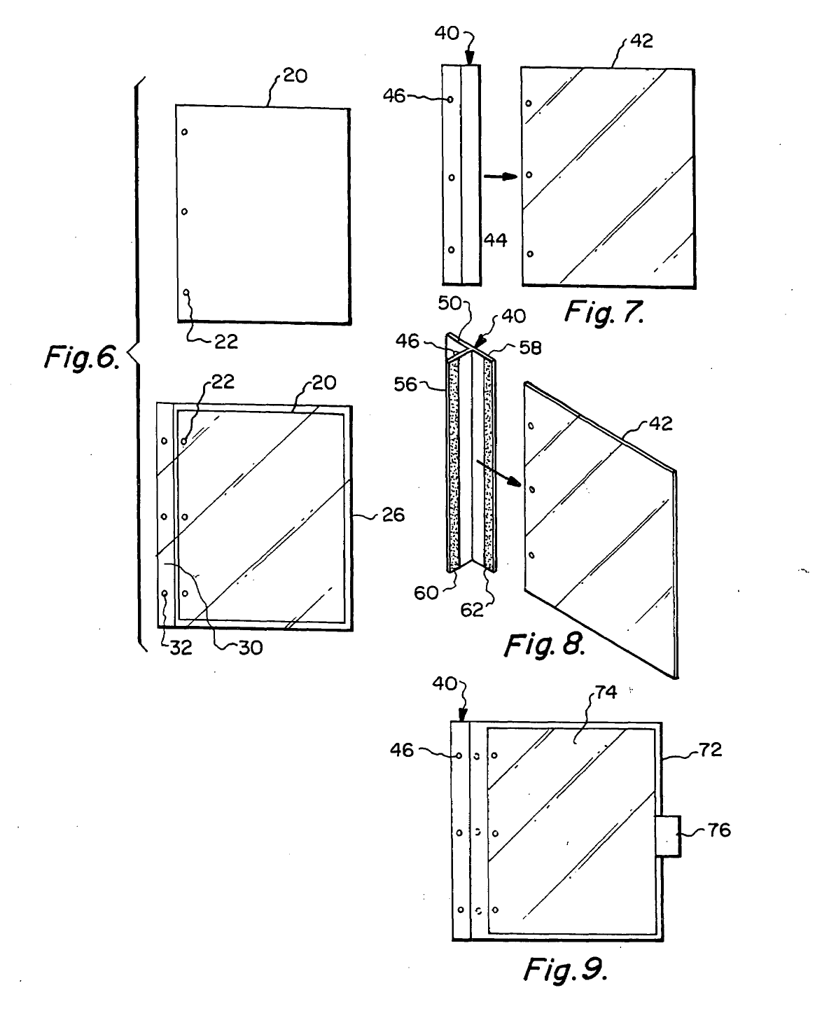

By turning now to FIG. 6, it can be observed that there is a sheet 20 similar to that sheet 20 of FIG. 4 having binder apertures 22 and which is included in a protective sleeve 26. Moreover, the protective sleeve 26 can be provided with a mounting strip 30 having binder apertures 32 as shown in FIG. 6. If there were other pages to be mounted in a binder along with the sheet 20 included in a protective sleeve 26, tabs on that sheet would not extend beyond the right-hand edge of the protective sleeve 26.

In order to overcome this problem, a sheet extender 40, as shown in FIG. 7, is added to a page 42 (corresponding to the page 20 of FIG. 6). The sheet extender is secured to the left-hand edge of the page 42 and would normally cover any mounting apertures 44 on the left-hand margin thereof. The sheet extender 40 is therefore provided with mounting apertures 46 which would fit within binder rings. In this case, it can be observed that by adding the sheet extender, the page 42 would have a width equal to at least the width of the overall combination of protective sleeve 26 and the page 20 incorporated therein, as shown in FIG. 6.

One embodiment of an extender strip is shown more fully in FIGS. 7-9 of the drawings. In any extender strip, there must be a section which increases the overall width of a page or sheet to which it is attached. Moreover, it must have some means for attachment to that page or sheet. In the embodiment of the invention as shown in FIGS. 7-9, the extender strip 40 comprises a longitudinal strip 50 adapted for attachment to the binder margin of the sheet 42 or otherwise a protective sleeve for that sheet. Thus, by referring to FIGS. 7 and 8, it can be seen that the sheet extender 40 is provided with a pair of flaps 56 and 58 which extend over opposite sides of the page or sheet 42. Moreover, it can be observed that the flaps 56 and 58 are each provided with adhesive coatings 60 and 62 for adhesive securement to the opposite flat surfaces of the sheet 42. In this way, the sheet 42 has been extended in width by a size equivalent to the sheet extender 40 but not including the dimensions of the flaps 56 and 58.

By further reference to FIGS. 7-9, it can be seen that the extender strip 40 is provided with the apertures 46 located to be mounted in the same binder as the page and protective sleeve. Thus, the apertures 46 on the extender strip will have the same spacing from one another as they are on the sheet 42.

In accordance with the above identified construction, when the sheet extender 40 is secured to a sheet, it can be observed that the apertures 46 will be mounted in a three-ring binder much in the same manner as a sheet 42.

In substance, and by further reference to FIGS. 7-9, it can be observed that since the extender strip 40 has added a width to a sheet 42, it will extend outwardly beyond other pages in the document. In this way, a tab 76 on an edge of the sheet will be readily engageable by the fingers of a user and readily observable.

It should also be understood that the sheet extender of the invention could also be added to a protective sheet. As a simple example, if all of the pages of a document were individually included in their own protective sleeves, then it may be necessary to add a sheet extender if some of those protective sleeves have a size differing from others. One such example is shown in FIG. 9 where there is a sheet extender 40 secured to a protective sleeve 72 having a page 74 included therein. A tab 76 is secured to the right-hand margin of that protective sleeve. In this way, it can be seen that this particular page would extend beyond other pages of a document.

It should be understood that the sheet extender or extender strip is preferably formed of a paper material, but preferably a somewhat heavy weight paper material so that it can withstand the abuses of turning pages and pulling on pages. In like manner, it could also be formed of plastic materials or the like.

It should also be recognized that it is not necessary to use a pair of flaps in the embodiment as shown. In place thereof, it is possible to use any means for attaching the extender strip to the protective sleeve. Thus, for example, the extender strip could have one flap for attachment to one side of the protective sleeve. Otherwise, any other means for attaching the extender strip could be employed.

It should also be recognized that for other binders, different types of extender strips would have to be provided. Thus, as a simple example, for a two-ring binder, it would be necessary to use only a pair of ring apertures. Again, any other means for binding could also be provided and the extender strips could also be made to be compatible with those other binding means.

Thus, there has been illustrated and described a unique and novel document indexing system which thereby fulfills all of the objects and advantages which have been sought. It should be understood that many changes, modifications, variations and other uses and applications will become apparent to those skilled in the art after considering the specification and the accompanying drawings which show embodiments of the invention. Therefore, any and all such changes, modifications, variations and other uses and applications which do not depart from the spirit and scope of the invention are deemed to be covered by the invention.

Having thus described the invention, what I desire to claim and secure by letters patent is:

1. A page size extender for application to a page of a document to allow a tab on a margin thereof to be readily visible and engageable, said size extender comprising;
a) an extender strip of a substrate having a width generally less than that of the page;
b) means for operatively securing the extender strip to an edge of the page to thereby increase the overall width of that page; and
c) whereby the extended width of the page allows a tab on an outer margin of that page to extend past other pages so that it is readily visible and engageable.

2. The page size extender of claim 1 further characterized in that said extender strip has a length approximately equal to or less than the length of the page.

3. The page size extender of claim 1 further characterized in that said page has means to secure the page in a binder, and the page extender strip comprises:
a) means to operatively secure the extender strip to a binder in the same manner as the page itself was securable to a binder.

4. The page size extender of claim 3 further characterized in that said page extender comprises apertures located in the same position as the page.

5. The page size extender of claim 1 further characterized in that said page is included within a page sleeve protector so that side margins of the page are not readily engageable, and said page extender comprises:
a) means to locate the page in a sleeve and the extender strip is secured to the sleeve and provides an extended side margin thereof.

6. The page size extender of claim 1 further characterized in that said means for operatively securing comprises:
a) an adhesive section on the page size extender.

7. The page size extender of claim 3 further characterized in that said means for operatively securing comprises:
a) an adhesive section on said page size extender.

8. The page size extender of claim 1 further characterized in that said page of the document is an index tab divider page.

9. A method of extending a size of a page in a document of similar pages, said method comprising:
a) securing a substrate of a page size extender to a side of a page along a margin thereof to thereby increase the overall width of the page;
b) operatively securing a tab to an opposite margin of that page so that the tab is readily visible and engageable; and
c) mounting said page and substrate to a binding of a binder so that the page extends beyond other pages of the document.

10. The method of extending a size of a page in a document of claim 9 further characterized in that said method comprises:
a) engaging a margin of that page with a pressure sensitive adhesive on the substrate.

11. The method of extending a size of a page in a document of claim 10 further characterized in that said method comprises:
a) providing on said page size extender a means to secure the extender within a binder with the page attached thereto much in the same manner that the page would have been secured without the page size extender.

12. The method of extending a size of a page in a document of claim 9 further characterized in that said method comprises attaching said page size extender to a pre-formed tab divider page.

13. The method of extending a size of a page in a document of claim 9 further characterized in that said method comprises:
a) mounting a page size extender to a margin of the page to thereby increase the overall width of the page; and
b) providing a tab to an opposite margin of the page.
